(19) United States
(12) Patent Application Publication
(10) Pub. No.: US 2005/0105184 A1
(43) Pub. Date: May 19, 2005

(54) Tunable filter membrane structures and methods of making

(75) Inventors: Eugene Yi-Shan Ma, Newton, MA (US); Mitchell S. Cohen, Bedford, MA (US); John Hazell, Somerville, MA (US)

Correspondence Address: WILMER CUTLER PICKERING HALE AND DORR LLP, 60 STATE STREET, BOSTON, MA, 02109, US

(73) Assignee: Aegis Semiconductor, Inc., Woburn, MA (US)

(21) Appl. No.: 10/960,439

(22) Filed: Oct. 7, 2004

Related U.S. Application Data
(60) Provisional application No. 60/509,200, filed on Oct. 7, 2003.
(60) Provisional application No. 60/509,379, filed on Oct. 7, 2003.

(51) Int. Cl. G02B 27/00

(52) U.S. Cl. 359/578; 359/577

(57) ABSTRACT

An optical device including: a substrate with a top surface and a bottom surface and a hole extending through the substrate from the top surface to the bottom surface; and a multilayered thin film structure fabricated on the substrate and forming a membrane over the hole, the multilayered thin film structure including a thermally tunable thin film optical filter structure at least a portion of which is positioned over the hole.

This application claims the benefit of U.S. Provisional Application No. 60/509,379, filed Oct. 7, 2003; and U.S. Provisional Application No. 60/509,200, filed Oct. 7, 2003.

### TECHNICAL FIELD

This invention relates to thermally tunable devices such as thermo-optically tunable thin film optical filters.

### BACKGROUND OF THE INVENTION

There is a family of devices that are based on thermo-optically tunable, thin-film optical filters. These devices, which are made from amorphous semiconductor materials, exploit what had previously been viewed as an undesirable property of amorphous silicon, namely, its large thermo-optic coefficient. The performance of these devices is based on trying to maximize thermo-optic tunability in thin-film interference structures, instead of trying to minimize it as is often the objective for conventional fixed filters. The devices are characterized by a pass band centered at a wavelength that is controlled by the temperature of the device. In other words, by changing the temperature of the device one can shift the location of the pass band back and forth over a range of wavelengths and thereby control the wavelength of the light that is permitted to pass through (or be reflected by) the device.

The basic structure for the thermo-optically tunable thin film filter is a single cavity Fabry-Perot type filter 10, as illustrated in FIG. 1a. The Fabry-Perot cavity includes a pair of thin film multi-layer interference mirrors 14a and 14b separated by a spacer 16. The thin film mirrors are made up of alternating quarter wave pairs of high and low index films. The two materials that are used for the layers are a-Si:H (n=3.67) and non-stoichiometric SiNx (n=1.77). In addition the spacer (“cavity”) also is made of amorphous silicon. To produce more complex pass band characteristics or more well defined pass bands, multiple cavities can be concatenated to form a multi-cavity structure.

To achieve control over the temperature of the device, at least some embodiments include a ZnO or polysilicon heater film 12 integrated into the multilayer structure. The heater film is both electrically conductive and optically transparent at the wavelength of interest (e.g. 1550 nm). Thus, by controlling the current that is passed through the film, one can control the temperature of the filter.

The thermal tuning that is achievable by this thermo-optically tunable filter is illustrated by FIG. 1b. The configuration used an amorphous silicon spacer with dielectric mirrors (tantalum pentoxide high index and silicon dioxide low index layers, deposited by ion-assisted sputtering, R=98.5% mirror reflectivity). That structure was heated in an oven from 25C to 229C. The tuning was approximately 15 nm or dλ/dT=0.08 nm/K.

### SUMMARY OF THE INVENTION

In general, in one aspect, the invention features an optical device including: a substrate with a top surface and a bottom surface and a hole extending through the substrate from the top surface to the bottom surface; and a multilayered thin film structure fabricated on the substrate and forming a membrane over the hole, the multilayered thin film structure comprising a thermally tunable thin film optical filter structure at least a portion of which is positioned over the hole.

Other embodiments include one or more of the following features. The multilayered thin film structure is fabricated on the top surface of the substrate. The multilayered thin film structure further includes a heater layer for heating the thermally tunable optical filter structure. The optical device also includes a heater element for heating the thermally tunable optical filter structure. The heater element is formed on the multilayered thin film structure. The thermally tunable optical filter structure is a thermo-optically tunable thin film optical filter structure. The heater element is a trace of resistive material that circumscribes a central region that is located over the hole. The trace of resistive material is a ring-shaped trace of resistive material. The thin film optical filter structure spans the opening. The thin film optical filter structure includes one or more layers comprising amorphous semiconductor, e.g. amorphous silicon. The multilayered thin film structure further includes a layer of silicon supporting the optical filter structure. The layer of silicon is a layer of crystalline silicon. The optical filter structure includes a plurality of thin film interference layers. At least some of the plurality of thin film layers includes amorphous silicon. Each of the layers among the plurality of thin film layers has a thickness that is roughly an integer multiple of λ/4. The hole is circular. The membrane above the hole has an open membrane structure or a closed membrane structure. The thin film optical filter structure includes a stack of multiple Fabry-Perot cavities.

Some of those embodiments also include one or more of the following features. The thin film optical filter structure forms the membrane over the hole and the device further includes an island of silicon attached to the underside of the membrane and positioned within the hole without contacting the substrate in which the hole is formed. The island of silicon is an island of crystalline silicon. The optical device further includes a silicon oxide layer between the island of silicon and the thin film optical filter structure.

In general, in another aspect, the invention features a method of fabricating an optical filter. The method includes: providing a substrate that has a silicon oxide layer on top of an underlying silicon layer; fabricating a thermally tunable thin-film optical filter structure on the substrate; forming a heater element above the oxide layer for heating an operating area of the optical filter structure; and etching into the backside of the substrate and down to the silicon oxide layer to expose a region of the silicon oxide layer that is under the operating area of the optical filter structure.

Other embodiments include one or more of the following features. Fabricating the thermally tunable thin-film optical filter structure on the substrate involves fabricating the thermally tunable thin-film optical filter structure on the substrate above the silicon oxide layer. Providing the substrate involves forming the silicon oxide layer on the underlying silicon layer. The method further includes removing the exposed region of the silicon oxide layer. The substrate includes the underlying silicon layer, the silicon oxide layer formed directly on the underlying silicon layer, and a crystalline silicon layer directly on top of the silicon oxide layer. Fabricating the thermally tunable thin-film optical filter structure on the substrate above the silicon oxide layer involves fabricating the thermally tunable thin-film optical filter structure above the crystalline silicon layer. Fabricating the thermally tunable thin-film optical filter structure on the substrate above the silicon oxide layer comprises fabricating the thermally tunable thin-film optical filter structure directly on the crystalline silicon layer. The method also includes forming an oxide on top of the crystalline silicon layer. Fabricating the thermally tunable thin-film optical filter structure on the substrate above the first-mentioned silicon oxide layer involves fabricating the thermally tunable thin-film optical filter structure directly on the oxide layer that is formed on top of the crystalline silicon layer. The method further includes, before etching into the backside of the substrate to expose the region of the first-mentioned silicon oxide layer, etching a trench into the backside of the substrate and down to the first-mentioned silicon oxide layer, wherein the trench circumscribes the region. Etching into the backside of the substrate to expose the region of the silicon oxide layer further involves etching the trench through the first-mentioned silicon oxide layer and down to the silicon oxide layer that is on top of the crystalline silicon layer.

In general, in still another aspect, the invention features a thermally tunable device including: a multilayer structure including a thermally tunable thin film optical filter having an operating region through which an optical signal passes during operation; and a heater fabricated on the multilayer structure for heating the operating region of the optical filter, wherein the heater includes n segments evenly distributed around the operating region of the filter, wherein n is an integer that is greater than 2 and wherein each segment is either linear or curvilinear in shape and has two ends that connect, respectively, to two different voltage supply lines.

Other embodiments include one or more of the following features. The value of n is 4. Each segment represents an arc of a circle. Each segment is made of a resistive material, e.g. platinum. The segments lie on a perimeter with separations between each segment.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1a shows the basic device structure of a thermo-optically tunable thin film filter.

FIG. 1b presents multiple plots of filter transmission characteristics showing the tuning range of a filter with thermo-optic spacer and dielectric mirrors.

FIGS. 2a-e illustrate the fabrication of a tunable filter membrane structure.

FIGS. 3a-f illustrate the fabrication of a tunable filter membrane structure that includes an underlying crystalline silicon island.

FIGS. 3g-i illustrate the fabrication of a tunable filter membrane structure that incorporates a crystalline silicon layer as part of the membrane.

FIGS. 3j-l illustrate the fabrication of open membrane structures.

FIGS. 3m-n show a top view of two open membrane structures.

FIG. 4 shows an improved ring heater design.

It should be understood that the figures are drawn for ease of illustration. The depicted structures are not drawn to scale nor are the relative dimensions intended to be accurate.

### DETAILED DESCRIPTION

Simple Membrane Structure:

The first embodiment is a thermo-optically tunable filter formed as a membrane on a silicon frame. The tunable filter which makes up the membrane is fabricated as described in previously filed applications and published articles. In general, it is a multi-layer thin film structure that includes one or more Fabry-Perot cavities, each of which has two thin film interference mirrors separated by a spacer. The mirrors and the spacers are made of a material that has an index of refraction that is characterized by a relatively high thermal coefficient. In this case, that material is amorphous silicon (a-Si), though other materials could also be used such as amorphous germanium (a-Ge). The resulting optical filter has a optical transmission curve with a band pass located at a wavelength that is determined by the design of the structure, e.g. the thickness of the films that make up the multi-cavity structure. By heating and cooling the optical filter, one can shift that band pass back and forth over a range that is determined by the design of the filter. A resistive ring heater that is formed on the tunable filter provides the mechanism by which the film is heated.

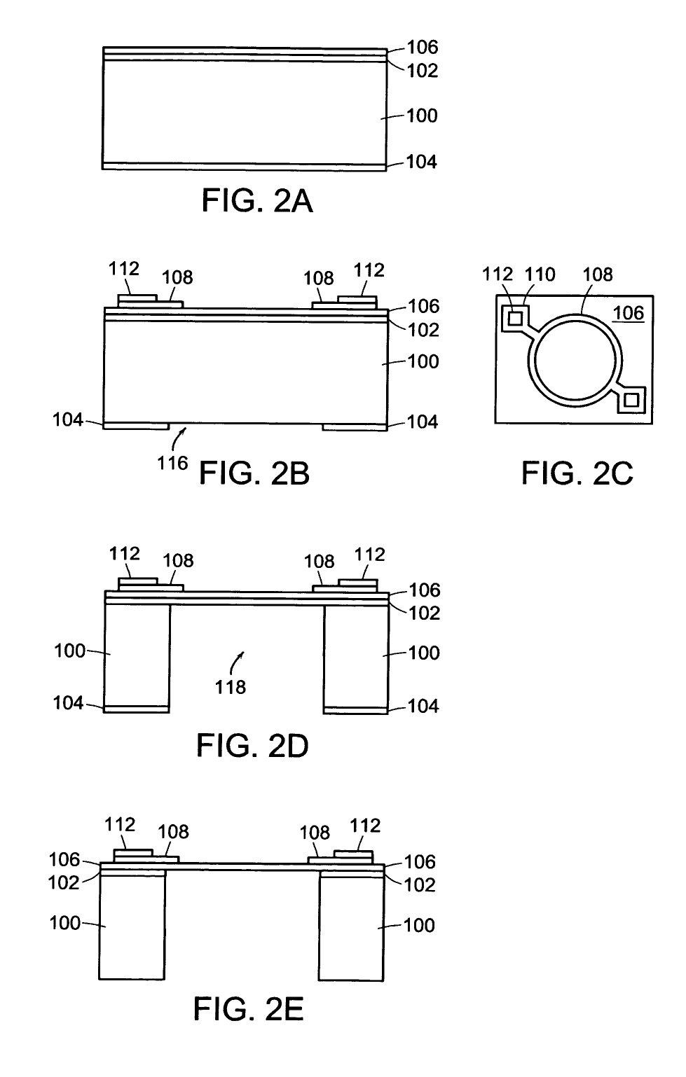

The primary process steps for fabricating this structure are illustrated in FIGS. 2a-e. Referring first to FIG. 2a, the starting material is a crystalline silicon substrate 100 (i.e., made of a single crystal material of the type in which microelectronic devices are fabricated). By using an oxidation process, e.g. wet oxidation, SiO₂ layers 102 and 104 are formed, respectively, on the front side and the backside of substrate 100. These SiO₂ layers serve as etch stop layers for later phases of the fabrication process.

After oxide layers 102 and 104 have been formed, a thermo-optically tunable thin film filter stack 106 is fabricated on oxide 102 that protects the top of the wafer, also referred to herein as topside oxide 102. This multi-layer filter stack 105 is fabricated as described in the following patent applications: U.S. Ser. No. 10/005,174, entitled “Tunable Optical Filter,” filed Dec. 4, 2001; U.S. Ser. No. 10/174,503, entitled “Index Tunable Thin-Film Interference Coatings,” filed Jun. 17, 2002; and U.S. Ser. No. 10/211,970, entitled “Tunable Optical Instruments,” filed Aug. 2, 2002, all of which are incorporated herein by reference. The number of interference films and the number of F-P cavities that are included in the filter depends on the band pass characteristics and other optical requirements that the optical filter must provide in the particular application for which it is being fabricated. In the described embodiment, the filter is a 4 period mirror single cavity (4 quarter wave high index, i.e., 4QW) design with an absentee silicon nitride (2QW) encapsulation layer. The first mirror pair is a 3QW c-Si layer (high index) followed by a 1QW low-index silicon nitride. Slight offsets in 3QW optical thickness are compensated for in the silicon nitride layer, if necessary.

Referring to FIGS. 2b and 2c, a ring heater 108 with contact pad regions 110 are then formed on top of the filter stack circumscribing the area through which the optical signal is designed to pass. These are made of a highly conductive material such as metal (e.g. platinum). Ring heater 108 is fabricated by using standard fabrication techniques that are well known to person skilled in the art. In general, it is made by first depositing a thin layer of metal over the top surface of the filter stack. Then, the deposited metal layer is patterned and etched to define the ring heater with its contact pad regions. Next, within the contact pad regions, another metal, such as titanium or gold, is deposited to define contact pads 112 to which electrical connection can be made by wires that will later be bonded to the pads.

To form the suspended membrane structure, the silicon below the filter is removed. This is accomplished by patterning the backside oxide layer to define an opening 116 (e.g. a circular opening) through oxide 116 in those areas in which the silicon is to be removed. After the openings are formed, the silicon is etched away until a well 118 is being formed reaches topside oxide 102 located just under filter structure 106. This can be done by using either a wet etch process or a dry etch process. In the described embodiment, a deep reactive ion etch (DRIE) process is used. The advantage of the DRIE process is that it more easily produces straight sidewalls on the well that is being etched and the SiO₂ layer under the filter stack serves as very effective etch stop layer that prevents the etch from going deeper than desired. After well 118 is formed, the portion of oxide layer 102 that is exposed by well 118 and that protects the backside of filter stack 106 is removed using an appropriate wet etch, e.g. a buffered HF solution (see FIG. 2e).

This process forms a composite structure having a very small thermal mass and supported by a surrounding silicon frame. When the optical filter is thermo-optically tunable, as described above, this yields fast, uniform, and efficient heating of the tunable optical filter element.

Earlier designs of the thermo-optic tunable thin film optical filters have used a doped polysilicon heater layer that was deposited on top of a transparent fused silica substrate (typically about 500 um thick) and the filter stack was on top of the polysilicon layer. One problem encountered when using the earlier design was thermal non-uniformity across the XY-plane of the heater. This was a result of the implementation of a sheet heater which tends to result in temperatures that are hotter at the center than at the edges. The non-uniformity in temperature translated into a tuning gradient across the filter itself which degraded its optical performance. Additionally, doped poly-silicon heaters have been known to exhibit resistance drift when exposed to high temperature over long periods of time. To counteract this problem, the drift was measured during an initial calibration process, and compensated for during signal processing. Stabilizing the heater resistance by using the structure disclosed herein removes the need for drift compensation in software.

The approach described above has multiple benefits over the earlier design. First of all, it uses fewer processing steps. In addition, the membrane device structure improves the optical performance of a thermo-optic tunable filter by providing more uniform heating and less optical scattering. It also provides a stable heating element whose resistance can be used to calibrate filter temperature and therefore wavelength. Additionally, it simplifies processing since this filter structure requires no anti-reflection coating.

In the above-described embodiment, the frame that supports the thermo-optic tunable filter element is made of silicon. Materials other than silicon can also be used. In addition, the membrane that was described above is a closed membrane, meaning that it is attached at all points around its periphery. One could alternatively have fabricated an open membrane that is attached to the frame only at discrete points about its periphery. That would produce even greater thermal isolation of the thermo-optically tunable element. In addition, instead of fabricating the heater as a ring heater formed on top of the filter stack, one could incorporate it into the membrane itself as a doped layer that is heated by passing current across it.

Membrane Structure Fabricated Using SOI Wafer:

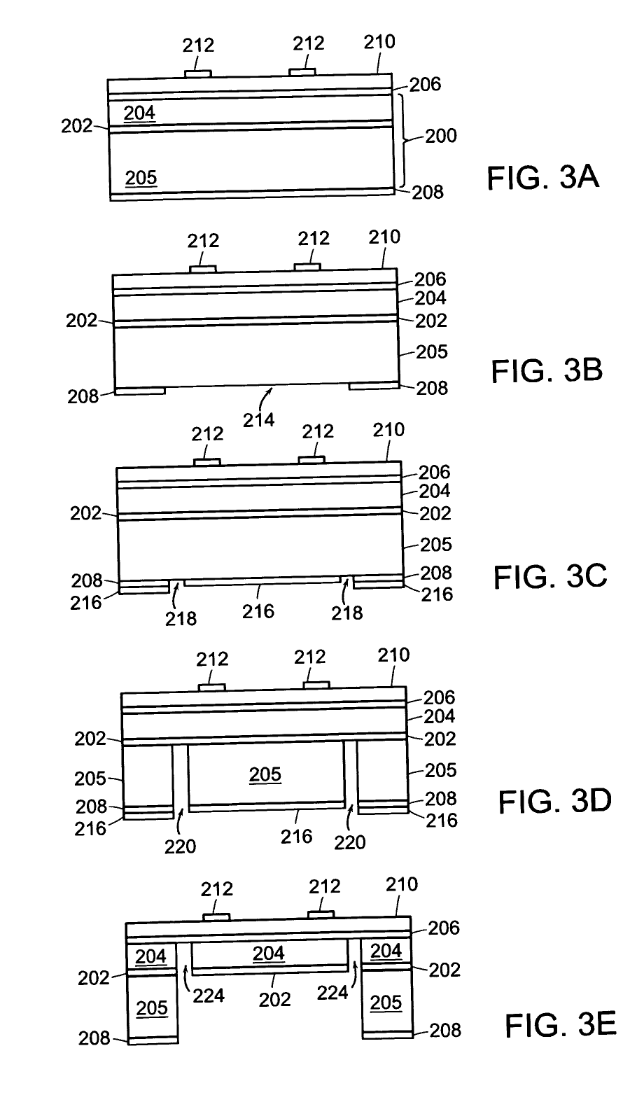

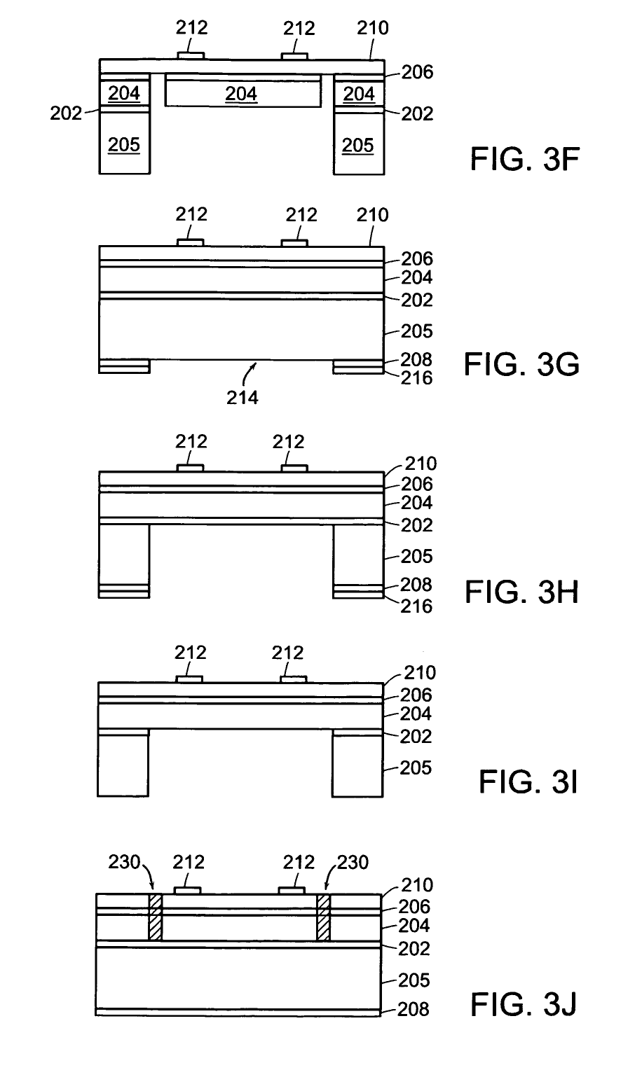

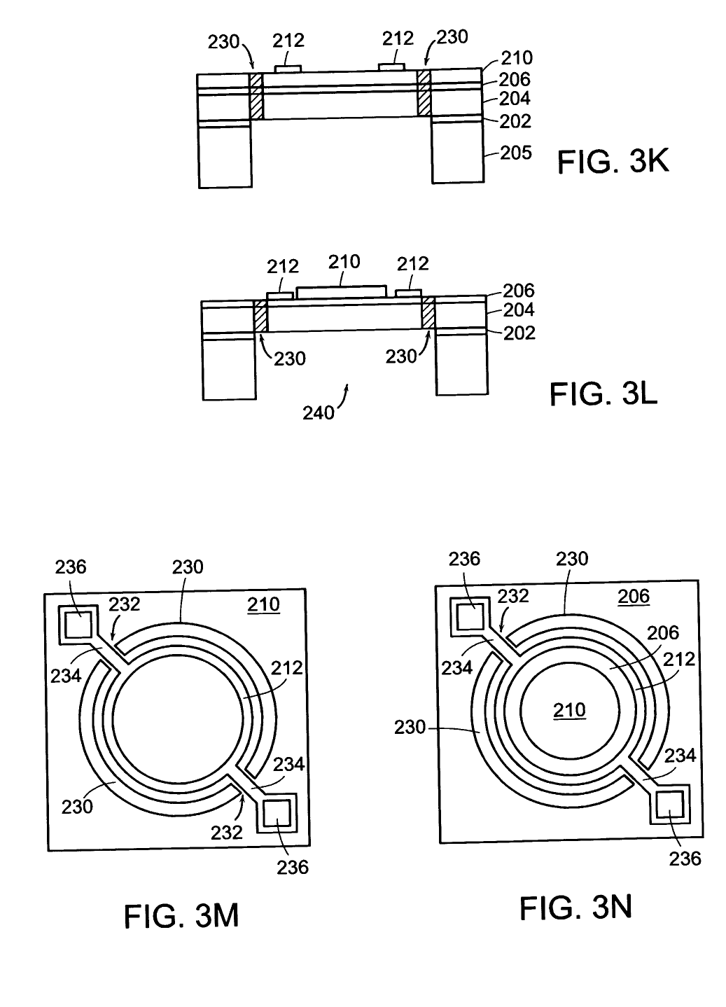

An improvement on the design described above includes a single crystal silicon layer beneath the filter stack, either as an island on the underside of the membrane (see FIG. 3f) or as part of the membrane itself (see FIG. 3i). When compared to the above-described membrane structure, use of the underlying crystalline silicon layer, either as an island on the membrane or as part of the membrane itself, provides structural rigidity to the filter so that it is less likely to deform or bow under thermal (expansion) stress. In addition, because the underlying material is a good thermal conductor, it also distributes heat from the ring heater more quickly and evenly across the filter than do membrane structures without such an island.

The fabrication of the structure with the crystalline silicon island will first be described followed by a description of the fabrication of a membrane which incorporates the crystalline silicon layer as part of the membrane.

The primary process steps for fabricating this structure are illustrated in FIGS. 3a-f. In this case, the starting material is a silicon-on-insulator (SOI) wafer 200 with a buried oxide (BOX) layer 202 located a distance “d” from the top surface. The upper silicon layer 204, also referred to as device layer 204, is high quality, single crystalline silicon. The lower silicon layer 205, also referred to as the handle substrate, is made of lower quality silicon since typically no devices are fabricated in this material and it simply acts as a support for the device layer.

By using, for example, a wet oxidation process, SiO₂ layer 206 and 208 are grown, respectively, on top of device layer 204 and on the backside of the wafer. As before, oxide layer 206, also referred to as topside oxide 206, will serve as a stop layer for deep etches that are later performed from the backside of the substrate. The optical filter structure 210 is then fabricated over the entire wafer on top of oxide 206. Since oxide 206 will be in the optical path of filter structure 210, its thickness needs to be carefully controlled so it acts either as an absentee layer or a reflection layer which forms part of the optical filter.

Next, a metal layer is deposited on top of filter structure 210 and, using standard fabrication techniques, that metal layer is then patterned and etched to form a ring heater 212 with contact pads.

Referring now to FIGS. 3b-f, by using conventional techniques, an opening 214 is etched into oxide 208 on the backside of the wafer to define a membrane region in which the silicon substrate will be removed beneath the filter stack. Then, photoresist 216 is deposited onto the backside of the wafer and it is exposed and processed to define regions 218 in which trenches will be etched into the silicon around the periphery of the membrane region. With photoresist 216 protecting the backside except in the defined exposed areas 218, a DRIE is used to etch deep trenches 220 into the defined regions extending down to BOX layer 202 which acts as a stop layer for the etch. Photoresist 216 protecting the silicon substrate is then removed and the etch process is continued to remove the silicon substrate material in the region between trenches 220, as shown in FIG. 3e. Since substrate is relatively thick, e.g. 450 μm, by the time the etch has removed the substrate material it will also have etched through the BOX layer (˜1 um) at the bottom of the previously etched trenches 220 and will have penetrated to topside thermal oxide layer 206 (see regions 224). Finally, BOX layer 202 over the island is removed, which also results in the removal of the portions of thermal oxide 206 that are at the bottom of the trench (see FIG. 3f).

If the silicon island (device layer) thickness is such that it can be incorporated into the filter stack design (e.g. its thickness is roughly equal to an integer multiple of a quarter-wavelength making it either an absentee layer or an interference layer), then an AR coat may not necessary. Otherwise, at this point, an AR coat needs to be deposited on the backside of the island.

The structure that is formed, like the earlier described structure shown in FIG. 2e, is a closed membrane structure. It can instead be fabricated as an open membrane (or “bridge”) structure by modifying the just-described fabrication process as follows. Referring to FIGS. 3j and 3m, after ring heater 212 has been formed, bridges 232 are defined and trenches 230 are etched from the topside down to BOX layer 202. Then, instead of etching the trenches shown in FIG. 3d, the entire region of silicon substrate material beneath the membrane is etched away up to BOX layer 202 after which BOX layer 202 is removed leaving the structure shown in FIG. 3k.

When viewed from above, as shown in FIG. 3m, the membrane is separated from the surrounding silicon frame by two trenches 230 except at two locations in which bridges 232 have been left. In this example, there are two bridges 232 (or connecting material) located opposite from each other. These two bridges connect the island to the surrounding material and provide a surface over which metalizations 234 electrically connecting to ring heater 212 to contacts pads 236 are deposited. Of course, the number of bridges that are used need not be limited to two. More bridges spaced around the periphery of the membrane can be used if desired or if appropriate.

In the example illustrated by FIG. 3j, the ring heater is fabricated on top of the filter structure. An alternative that puts the ring heater into direct thermal contact with the underlying device layer is shown in FIGS. 3l and 3n. In that case, the filter structure is etched away in all areas except within those areas that are directly above the underlying well regions 240. Sufficient space is left between trenches 230 that defining bridges 232 and the filter stack 210 to permit ring heater 212 to be deposited directly onto the exposed topside oxide layer 204 just above the supported island of crystalline silicon.

As noted earlier, an alternative design to using a silicon island beneath the filter stack is to incorporate the crystalline silicon layer directly into the membrane itself as a continuous, unpatterned sheet. This structure trades off some thermal isolation for reduced processing complexity. Such a structure is fabricated as follows. Instead of defining trench regions 218 as shown in FIG. 3c, the entire area 214 on the backside left exposed and photoresist 216 is patterned onto the remaining backside oxide layer 208 as shown in FIG. 3g. Then, an entire membrane region 240 beneath the ring heaters is etched away up to the BOX layer 202 (see FIG. 3h). After BOX layer 202 is exposed in that way, photoresist 216 is removed and the exposed portion of BOX layer 202 as well as the oxide on the back of the substrate too is etched away leaving a membrane structure which includes the filter stack on top of the silicon layer, both of which extend across the opening from one side to the other. This design provides for less thermal isolation of the active/heated portion of the filter stack than the design depicted in FIG. 3f but it is sufficient for many applications.

In the structure depicted in FIG. 3i, topside oxide layer 206 is not required as an etch stop layer. So, in this design it can simply be eliminated in which case the filter stack is fabricated directly on top of the crystalline silicon device layer. That has an advantage of reducing the number of fabrication steps.

As was also noted above, to eliminate the need for an AR coating requires that the device layer thickness, d, be roughly an integer multiple of quarter wavelengths (note that compensation layers can be grown to offset slight variations in the thickness of this layer). To achieve this level of thickness control, the “smart cut” process is used to fabricate the SOI wafer.

The “smart cut” process uses two polished Si wafers, wafer A and wafer B. An oxide is thermally grown on wafer A, after which hydrogen is implanted through the oxide layer and into the underlying silicon to a predetermined depth. Wafer A is then hydrophilicly bonded to wafer B under the application of pressure and a temperature of about 400-600° C. During a subsequent heat treatment, the hydrogen ion implantation acts as an atomic scalpel enabling a thin slice of crystalline film (of thickness d) to be cut from wafer A (i.e., the donor wafer) and transferred on top of wafer B (i.e., the receiving wafer).

The bond is strengthened by a second, subsequent anneal at about 1100° C. In the resulting structure, the thin crystalline Si film (generally referred to as the “device” layer) is bonded to the oxide film which is now firmly bonded to wafer B (also referred to as the “handle” layer). The device layer is typically 300-500 nm thick with high accuracy (about +30-40 nm). A final light polish of the exposed Si-film surface is then carried out to ensure a very smooth surface.

Wafers that are made by this process are commercially available from S.O.I.TEC Silicon On Insulator Technologies (Soitec) of Bemin, France.

Modified “Ring” Heater Design:

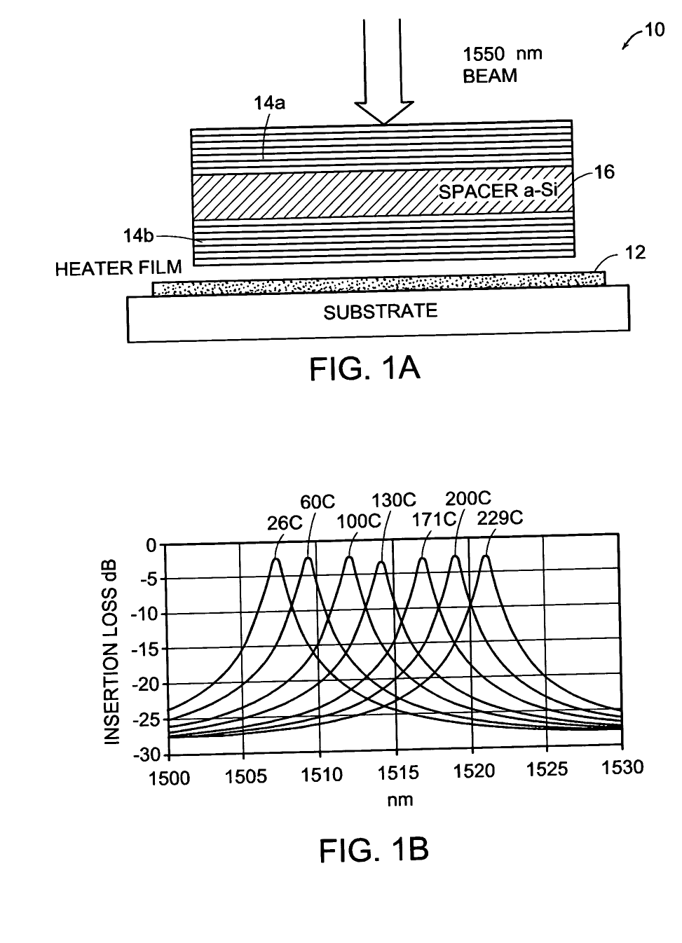

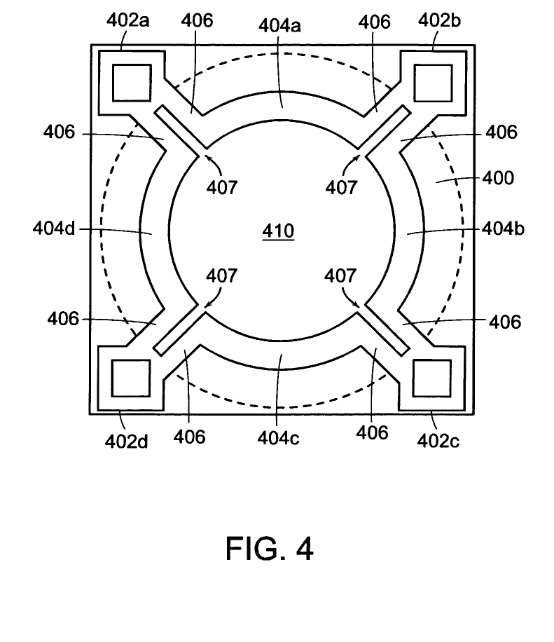

A modification to the design of the ring heater that produces a further reduction in the thermal gradients and stresses that occur across the membrane is shown in FIG. 4. This is an alternative to the design that is shown, for example, in FIG. 1c, which includes only two contact pads one on the opposite side of the ring heater from the other. In this design, ring heater 400 has four contact pads 402a-d equally spaced around the ring heater. One pair of contact pads that are directly opposite each other (i.e., contact pads 402a and 402c) is connected to one terminal (or polarity) of the drive circuit (not shown) and the other pair of contact pads that are directly opposite each other (i.e., contact pads 402b and 402d) is connected to the other terminal (or polarity) of the drive circuit. As compared to the design shown in FIG. 1c, this design has more axes of symmetry. In the design of FIG. 1c, there is single “strong” axis of symmetry, which is the axis passing through the two contact pads that are on opposite sides of the ring. In the design of FIG. 4, there are two balanced axes of symmetry which are orthogonal to each other. Each set of opposed contact pads represents a corresponding axis of symmetry for the device. Increasing the axes of symmetry from one to two improves the thermal and mechanical uniformity profile across the filter surface during heating which translates into improved optical performance and reliability.

In addition, in ring heater 400 includes four separate heating elements 404a-d (or segment) that are electrically connected together at points that are located away from a central region 410 that is being heated by the heater. Each heating element includes a segment of a circular ring that spans about 90° of the circle. On the circle which the group of segments form, each segment is separated from its neighbor by a gap 407. And at each end of the segment there is a conductive path 406 leading radially away from central region 410 and towards an associated contact pad to which it is connected. In other words, the segments are electrical connected to each other at locations that are radially outside of the central heating ring (in this particular example it is at the contact pads but it could be before that). Moving the electrical connection points between the segments to locations that are outside of the central heating elements also appears to improve the uniformity of the heating of the working portion of the tunable filter.

This heater design improves the mechanical performance of the membrane which in turn improves the optical performance of the filter, specifically reducing the stress-induced polarization dependent loss (PDL) to below 0.2 dB at 0.5 dB passband. Low PDL is required in most telecom applications and is difficult to achieve in most tunable filters unless there is some additional compensation scheme. This structure makes it possible to more easily achieve that level of performance. In addition, such a structure also permits open membrane designs.

The segments shown here are curvilinear (more specifically, segments of a circle) but they could also be linear. In many applications, the supply voltage that is available for the heater is down around 5 volts which places a serious limitation on the design of the heater especially if control over a wide temperature range is desired. The overall resistivity must be quite low meaning that the path length must be short thus limiting one to straight or curved segments, as opposed to serpentine structures.

The structures described above have particular usefulness in connection with the thermo-optically tunable thin film optical filters. But these structures would also be useful for other devices in which a heater with excellent electrical stability, high resistance to delamination and rupture, and/or good transparency in the IR without scattering is required.

In the embodiments described above, the optical filter was fabricated on top of the substrate or the crystal silicon layer prior to etching the well under the filter. It is also possible to first fabricate a membrane, e.g. an SiO₂ or crystal silicon layer, etch the well, and fabricate the filter in the well on the backside of the membrane.

Though the descriptions presented above generally focused on the fabrication of an individual device on a wafer substrate, in reality there will be many such devices fabricated on a single wafer and they will later be separated into individual components by cutting and dicing the wafer to produce many individual die.

Other embodiments are within the following claims.

1. An optical device comprising:
a substrate with a top surface and a bottom surface and a hole extending through the substrate from the top surface to the bottom surface; and
a multilayered thin film structure fabricated on the substrate and forming a membrane over the hole, said multilayered thin film structure comprising a thermally tunable thin film optical filter structure at least a portion of which is positioned over the hole.

2. The optical device of claim 1, wherein the multilayered thin film structure is fabricated on the top surface of the substrate.

3. The optical device of claim 2, wherein the multilayered thin film structure further comprises a heater layer for heating the thermally tunable optical filter structure.

4. The optical device of claim 2 further comprising a heater element for heating the thermally tunable optical filter structure.

5. The optical device of claim 2 wherein the heater element is formed on the multilayered thin film structure.

6. The optical device of claim 5, wherein the thermally tunable optical filter structure is a thermo-optically tunable thin film optical filter structure.

7. The optical device of claim 5, wherein the heater element is a trace of resistive material that circumscribes a central region that is located over the hole.

8. The optical device of claim 7, wherein the trace of resistive material is a ring-shaped trace of resistive material.

9. The optical device of claim 5, wherein the thin film optical filter structure spans the opening.

10. The optical device of claim 5, wherein the thin film optical filter structure includes one or more layers comprising amorphous semiconductor.

11. The optical device of claim 10, wherein the amorphous semiconductor is amorphous silicon.

12. The optical device of claim 5, wherein the multilayered thin film structure further comprises a layer of silicon supporting the optical filter structure.

13. The optical device of claim 12, wherein the layer of silicon is a layer of crystalline silicon.

14. The optical device of claim 5, wherein the optical filter structure comprises a plurality of thin film interference layers.

15. The optical device of claim 14, wherein at least some of the plurality of thin film layers comprise amorphous silicon.

16. The optical device of claim 14 for use with an optical signal of wavelength λ, wherein each of the layers among the plurality of thin film layers has a thickness that is roughly an integer multiple of λ/4.

17. The optical device of claim 5, wherein the hole is circular.

18. The optical device of claim 5, wherein the membrane above the hole has an open membrane structure.

19. The optical device of claim 5, wherein the membrane above the hole has a closed membrane structure.

20. The optical device of claim 5, wherein the thin film optical filter structure comprises a stack of multiple Fabry-Perot cavities.

21. The optical device of claim 5, wherein the thin film optical filter structure forms the membrane over the hole and said device further comprises an island of silicon attached to the underside of the membrane and positioned within the hole without contacting the substrate in which the hole is formed.

22. The optical device of claim 21, wherein the island of silicon is an island of crystalline silicon.

23. The optical device of claim 22, further comprising a silicon oxide layer between the island of silicon and the thin film optical filter structure.

24. A method of fabricating an optical filter, said method comprising:
providing a substrate that has a silicon oxide layer on top of an underlying silicon layer;
fabricating a thermally tunable thin-film optical filter structure on the substrate;
forming a heater element above the oxide layer for heating an operating area of the optical filter structure; and
etching into the backside of the substrate and down to the silicon oxide layer to expose a region of the silicon oxide layer that is under the operating area of the optical filter structure.

25. The method of claim 24, wherein fabricating the thermally tunable thin-film optical filter structure on the substrate involves fabricating the thermally tunable thin-film optical filter structure on the substrate above the silicon oxide layer.

26. The method of claim 25, wherein providing said substrate comprises forming the silicon oxide layer on the underlying silicon layer.

27. The method of claim 25 further comprising removing the exposed region of the silicon oxide layer.

28. The method of claim 25, wherein the substrate includes the underlying silicon layer, the silicon oxide layer formed directly on the underlying silicon layer, and a crystalline silicon layer directly on top of the silicon oxide layer.

29. The method of claim 28, wherein fabricating the thermally tunable thin-film optical filter structure on the substrate above the silicon oxide layer comprises fabricating the thermally tunable thin-film optical filter structure above the crystalline silicon layer.

30. The method of claim 29, wherein fabricating the thermally tunable thin-film optical filter structure on the substrate above the silicon oxide layer comprises fabricating the thermally tunable thin-film optical filter structure directly on the crystalline silicon layer.

31. The method of claim 29 further comprising forming an oxide on top of the crystalline silicon layer.

32. The method of claim 31, wherein fabricating the thermally tunable thin-film optical filter structure on the substrate above the first-mentioned silicon oxide layer comprises fabricating the thermally tunable thin-film optical filter structure directly on the oxide layer that is formed on top of the crystalline silicon layer.

33. The method of claim 32 further comprising, before etching into the backside of the substrate to expose the region of the first-mentioned silicon oxide layer, etching a trench into the backside of the substrate and down to the first-mentioned silicon oxide layer, said trench circumscribing said region.

34. The method of claim 33 wherein etching into the backside of the substrate to expose the region of the silicon oxide layer further comprises etching the trench through the first-mentioned silicon oxide layer and down to the silicon oxide layer that is on top of the crystalline silicon layer.

35. A thermally tunable device comprising:
a multilayer structure comprising a thermally tunable thin film optical filter having an operating region through which an optical signal passes during operation; and
a heater fabricated on the multilayer structure for heating the operating region of the optical filter,
wherein the heater comprises n segments evenly distributed around the operating region of the filter, wherein n is an integer that is greater than 2 and wherein each segment is either linear or curvilinear in shape and has two ends that connect, respectively, to two 9 different voltage supply lines.

36. The thermally tunable device of claim 35, wherein n is equal to 4.

37. The thermally tunable device of claim 35, wherein each segment represents an arc of a circle.

38. The thermally tunable device of claim 35, wherein each segment is made of a resistive material.

39. The thermally tunable device of claim 38, wherein the resistive material is platinum.

40. The thermally tunable device of claim 35, wherein the segments lie on a perimeter with separations between each segment.
